(19) United States
(12) Patent Application Publication
(10) Pub. No.: US 2013/0342805 A1
(43) Pub. Date: Dec. 26, 2013

(54) MULTI-FUNCTIONAL EYEGLASSES

(71) Applicant: Ming Chuan HUANG, Taipei Hsien (TW)

(72) Inventor: Ming Chuan HUANG, Taipei Hsien (TW)

(21) Appl. No.: 13/528,861

(22) Filed: Jun. 21, 2012

(51) Int. Cl. G02C 11/00

(52) U.S. Cl. 351/158

(57) ABSTRACT

A multi-functional eyeglasses includes two lenses and an eyeglass frame including two supporting rods and two lens frames; each lens frame being installed with a respective one of the lenses. The multi-functional eyeglasses has a processor, a memory and a display. The eyeglasses can be installed with a receiver and a transmitter, a GPS positioning system, a Bluetooth system, a camera, a sound control system, a TV circuit, a scanner, a clinical thermometer, a thermometer, a batter, a solar energy chip, USP plugs, switching set. This, the functions of eyeglasses are expanded extremely so as to provide great convenience to users.

### FIELD OF THE INVENTION

The present invention related to eyeglasses, and in particular to multi-functional eyeglasses.

### BACKGROUND OF THE INVENTION

Almost all people need wear a pair of eyeglasses. In current life, eyeglasses have become a necessary device. Conventionally, the eyeglasses are not improved dramatically. Although many improvements are disclosed about eyeglasses, but these improvements are aim to the original functions of eyeglasses or try to add some decorated features to the eyeglasses. However currently electronic technologies are advanced greatly so that many electronic devices are more and more compact with very small sizes. Furthermore, most electronic devices need display screens for displaying results or some desired data. Based on current technology, to combine electronic screens to the lenses of eyeglasses is very easy and ready to use. Thus, based on this viewpoint, the present invention desired to combine many electronic devices to eyeglasses for expanding functions of electronic devices to extremity and thus users need not carry many different electronic devices individually.

### SUMMARY OF THE INVENTION

The object of the present invention is to provide a novel multi-functional eyeglasses, wherein the present invention integrates daily life used electronic devices to the eyeglasses to enrich the functions of the eyeglasses. Therefore, the user can use these electronic devices conveniently without carrying these devices individually. Moreover, the present invention can combine the lenses and display in one eyeglass frame so that the user can view the data on the display easily and conveniently. Therefore, by the present invention, the functions of conventional eyeglasses are expanded extremely.

To achieve above object, the present invention provides a multi-functional eyeglasses, wherein the multi-functional eyeglasses comprising: a processor on the eyeglass frame receiving signals from the receiver, and processes the signals; a memory connected to the processor installed on the eyeglass frame; and a display connected to the processor for displaying data from the processor; a receiver; the receiver being a wired or wireless receiver; the receiver being one of a signal receiver for receiving signals through RF waves or infrared waves or a laser receiver for receiving laser light, or an infrared receiver for receiving infrared waves; and a transmitter connected to the processor for emitting signals processed by the processed to a far end device; and thus a remote control function can be realized; a speaker connected to an audio circuit and then connected to the processor emitting sounds based on the signals from the processor; a microphone connected to an audio circuit and then connected to the processor serves to receiver sounds.

### BRIEF DESCRIPTION OF THE DRAWINGS

FIG. 1 is a schematic view of the present invention.

FIG. 2 is a perspective view of the present invention.

FIG. 3 shows an application of the present invention.

FIG. 4 shows the function block diagram of the present invention.

FIG. 5 is a block diagram showing the TV system of the present invention.

FIG. 6 is a block diagram showing the Bluetooth system of the present invention.

FIG. 7 is a block diagram showing the sound control system of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

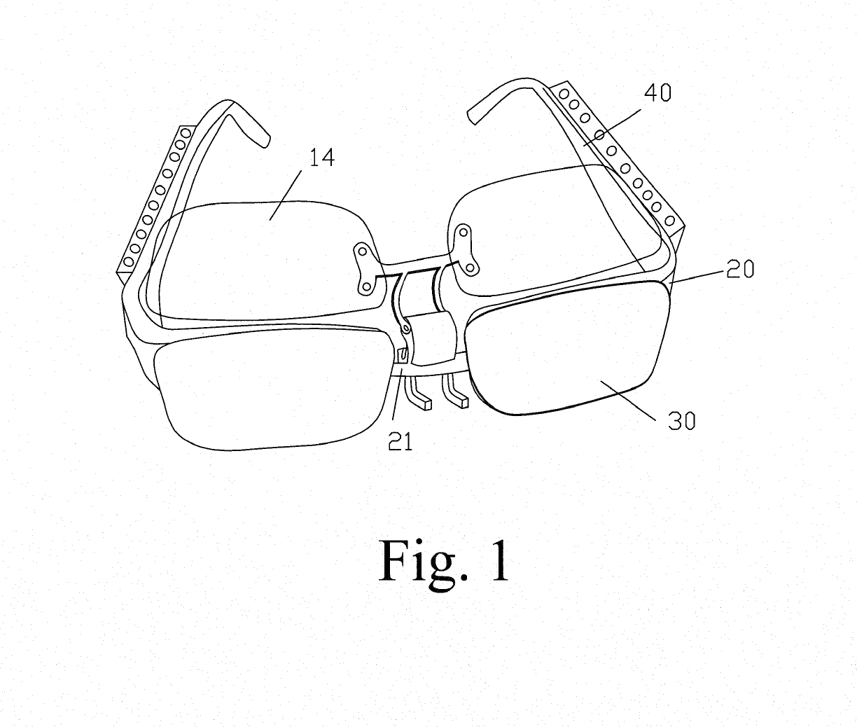

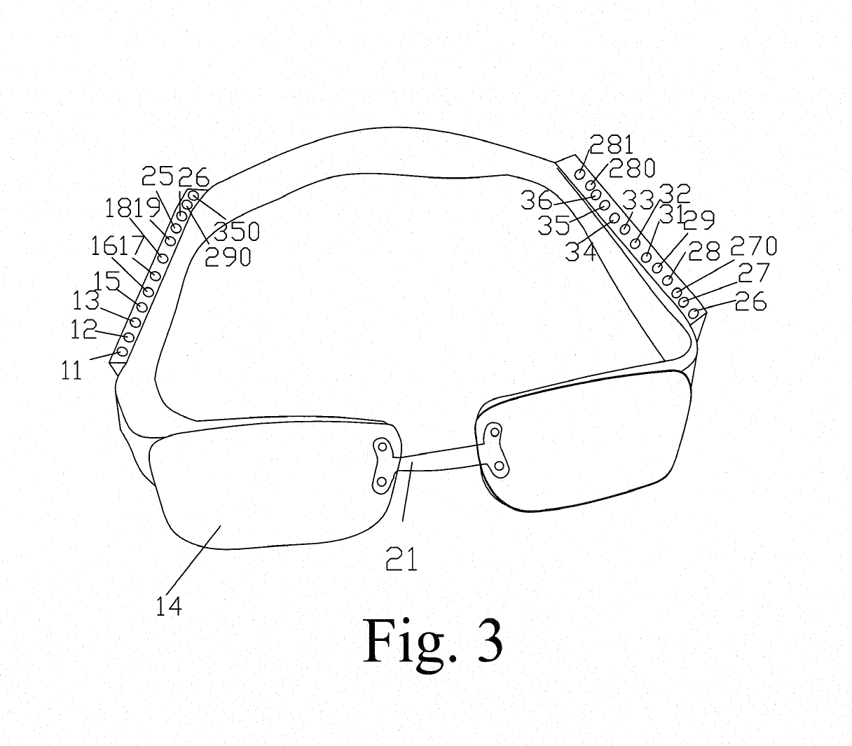

A glass as illustrated in FIGS. 1 to 3 includes two lenses 30 and an eyeglass frame 10. The eyeglass frame includes two supporting rods 40 and two lens frames 20. Each lens frame 30 is installed with a respective lens 30. The lenses are made by glass, plastics, rubber, acrylics, etc..

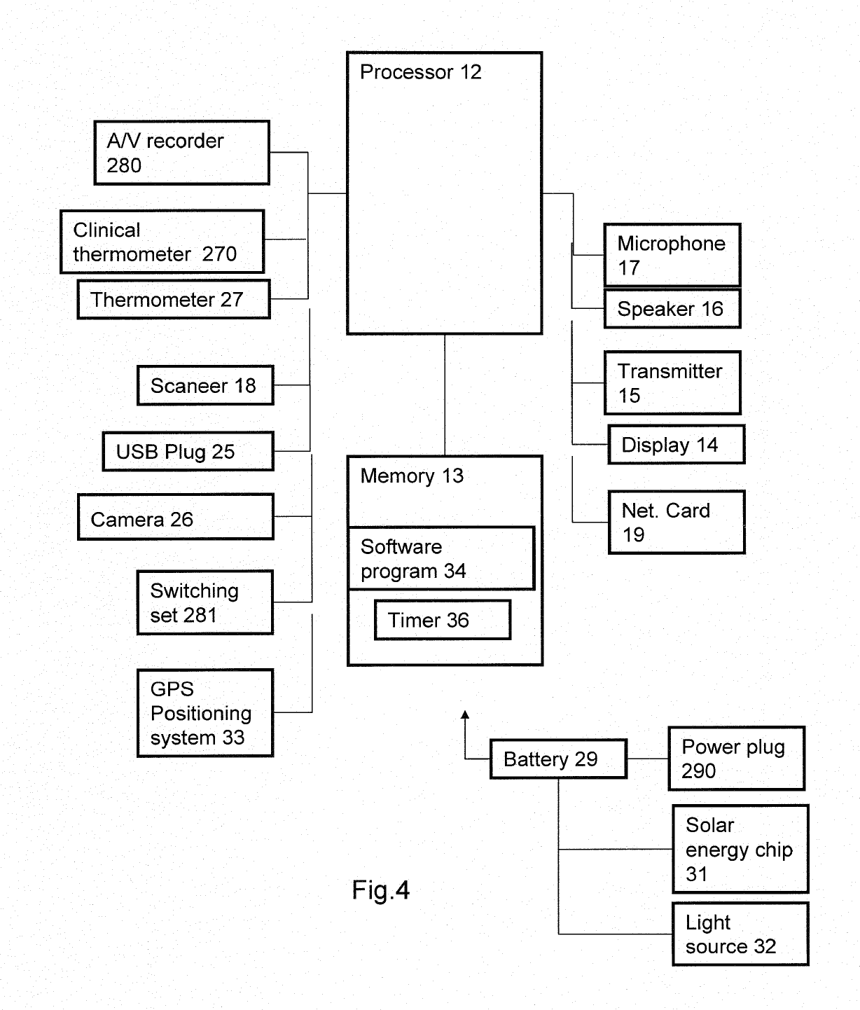

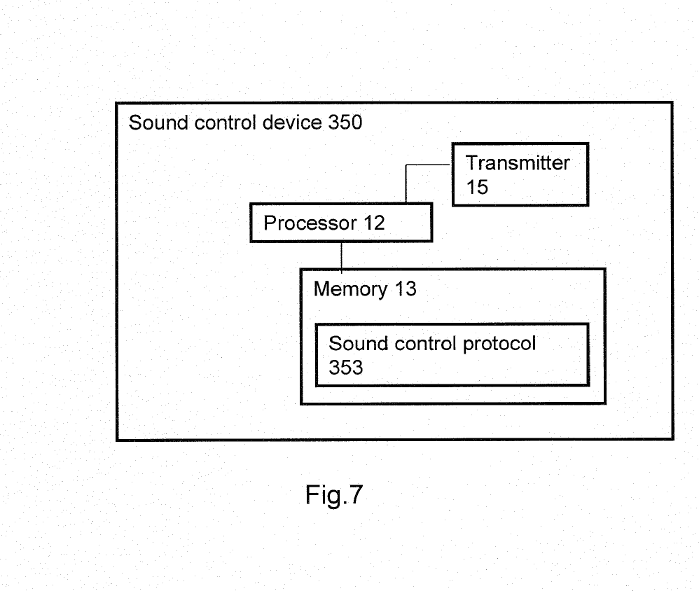

The eyeglass frame 10 is installed with the following devices (referring to FIGS. 1 to 7).

A receiver 11 (may on the lens frames 30 or on the supporting rods 40). The receiver 11 is a wired or wireless receiver. The receiver 11 is one of a signal receiver for receiving signals through RF waves or infrared waves; or a laser receiver for receiving laser light; or an infrared receiver for receiving infrared waves.

A processor 12 installed on the eyeglass frame 10 receives the signals from the receiver and processes the signals.

A memory 13 connected to the processor 12 installed on the eyeglass frame 10 serves for storing data used in the present invention.

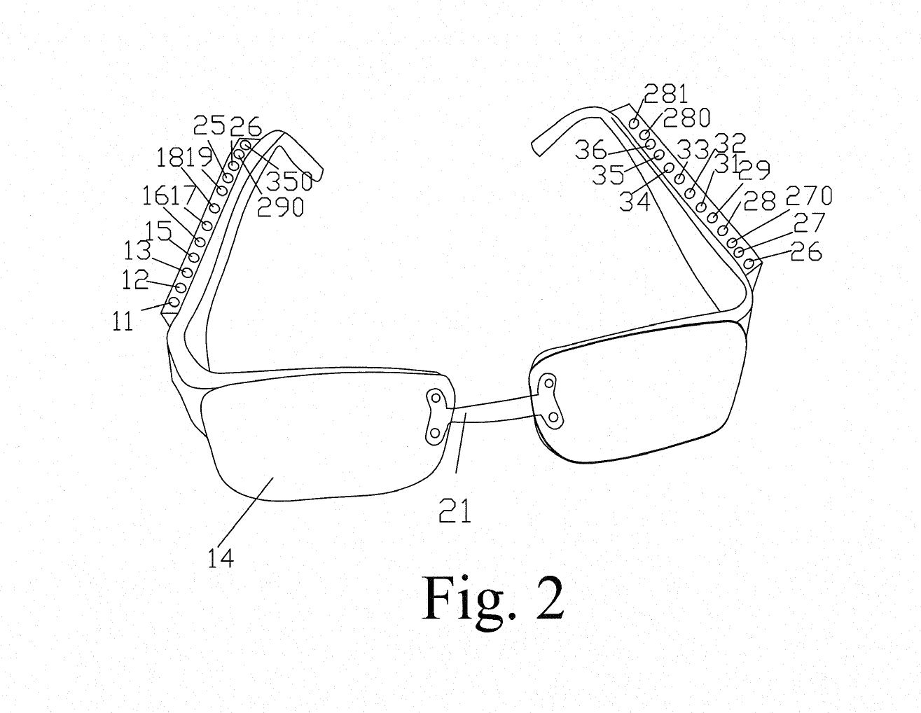

A display 14 connected to the processor 12 serves for displaying data from the processor 12. In FIGS. 1 and 2, it is illustrated that the display 14 may be combined with the lenses 20. In FIG. 2, it is illustrated that the display is independent from the lenses 20. As the user desires view images, he (or she) can rotate the display to a position conveniently from being viewed by user's eyes. The display 14 is one of an LCD display, an LED display, an OLED display, or a scrollable display. Furthermore, the display may present virtual images.

The display may be added with a touch control device for signal inputting by users.

A transmitter 15 connected to the processor 12 serves to emit signals processed by the processor to a far end device. Thus a remote control function can be realized.

A speaker 16 connected to an audio circuit (not shown) and then connected to the processor 12 emits sounds based on the signals from the processor 12.

A microphone 17 connected to an audio circuit (not shown) and then connected to the processor 12 serves to receive sounds. Thus integration of the speaker 16, the microphone 17, the receiver 11, the transmitter 15, the processor 12, etc. will forma portable device.

A scanner 18 connected to the processor 12 serves for scanning images and then storing the images in the memory 13. The images can be printed by a printer.

A network card 19 connected to the processor 12 serves to connect the present invention with other devices through networks. By the network card 19, the present invention can be connected to a cloud servo so as to expand the functions of the present invention further.

A USB plug 25 connected to the processor 12 serves to couple with another USB plug so as to be connected to an external device. In the present invention, the USB plug 25 can receive external audio/video data with MP3 or MP4 format.

A camera 26 connected to the processor 12 serves for capturing external images which can be stored in the memory 13 or displayed through the display 14.

A clinical thermometer 27 connected to the display 14 serves for measuring body temperatures which can be displayed on the display 14.

A thermometer 270 connected to the display 14 serves for measuring external temperature which can be displayed through the display 14.

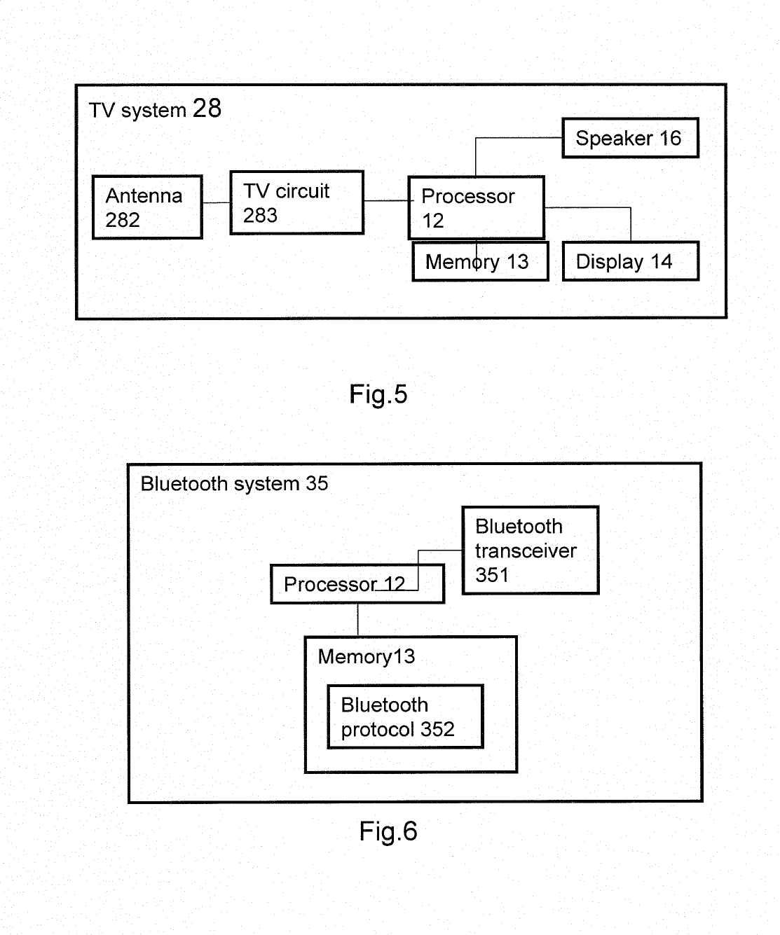

An antenna and TV (television) related circuits 28 serves to wirelessly receive TV signals and display on the display 14 so that user can view TV programs through the eyeglasses of the present invention. The antenna and TV related circuit 28 includes an antenna 282 and a TV circuit 283 (as illustrated in FIG. 5)

An audio/video recording device 280 serves for recording external A/V data which are stored in the memory 13 or displayed through the display 14.

A switch set 281 serves for switching the system of the present invention and turning on and off all units of the present invention.

A battery 29 serves for supplying power to all elements of the present invention.

A power plug 290 serves to connect to external electric power source for supplying power to all units of the present invention.

At least one solar energy chip 31 connected to the battery 29 serves for receiving solar power and converting the solar power to electric power which is then stored in the battery 29.

A light source 32 connected to the battery serves for emitting light as guiding light at night.

A GPS positioning system 33 connected to the display 14 serves for capturing satellite signals to get the position of the eyeglasses of the present invention. Furthermore, the position can be matched to a map and then is displayed on the display 14, or the position can be emitted out for informing where the eyeglass is so as to help the finding of the eyeglasses as the eyeglasses are lost.

At least one computer game software 4 is stored on the memory 13. Through the display 14, processor 12, speaker, users can play the game.

A Bluetooth system 35 (referring to FIG. 6) has a Bluetooth transceiver 351 and a Bluetooth protocol 352 built in the processor 12 and the memory 13 for wireless communication.

A sound control device 350 has a sound control protocol 353 built in the processor 12 and the memory 13 for sound-controlling external devices, such as lights, TV, etc.

In the present invention, the receivers can receive financial data, such as stock data, futures data, and exchange rates, etc.

Further, the processor 12 has a timer 36 for showing time of the display 14.

The present invention integrates daily life used electronic devices to the eyeglasses so as to enrich the functions of the eyeglasses. Therefore, the user can use these electronic devices conveniently without carrying these devices individually. Moreover, the present invention can combine the lenses and display in one eyeglass frame so that the user can view the data on the display easily and conveniently. Therefore, by the present invention, the functions of conventional eyeglasses are expanded extremely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A multi-functional eyeglasses including two lenses and an eyeglass frame including two supporting rods and two lens frames; each lens frame being installed with a respective one of the lenses; the multi-functional eyeglasses comprising:
a processor on the eyeglass frame receiving signals from the receiver, and processing the signals;
a memory connected to the processor and installed on the eyeglass frame; and
a display connected to the processor for displaying data from the processor.

2. The multi-functional eyeglasses as claimed in claim 1, further comprising:
a receiver; the receiver being a wired or wireless receiver; the receiver being one of a signal receiver for receiving signals through RF waves or infrared waves or a laser receiver for receiving laser light, or an infrared receiver for receiving infrared waves; and
a transmitter connected to the processor for emitting signals processed by the processor to a far end device; and thus a remote control function can be realized.

3. The multi-functional eyeglasses as claimed in claim 2, further comprising:
a speaker connected to an audio circuit and then connected to the processor for emitting sounds based on the signals from the processor; and
a microphone connected to an audio circuit and then connected to the processor serves to receiver sounds.

4. The multi-functional eyeglasses as claimed in claim 1, further comprising:
a scanner connected to the processor for scanning images.

5. The multi-functional eyeglasses as claimed in claim 1, further comprising:
a network card connected to the processor for network connecting wirelessly or to a cloud servo.

6. The multi-functional eyeglasses as claimed in claim 1, further comprising:
a USB plug connected to the processor for coupling with another USB plug so as to be connected to an external device.

7. The multi-functional eyeglasses as claimed in claim 6, wherein the USB plug receives external audio/video data with MP3 or MP4 format.

8. The multi-functional eyeglasses as claimed in claim 1, further comprising:
a camera connected to the processor for capturing external images.

9. The multi-functional eyeglasses as claimed in claim 3, further comprising:
an antenna and TV (television) related circuits serves to wirelessly receive signals and display on the display.

10. The multi-functional eyeglasses as claimed in claim 3, further comprising:
an audio/video recording device for recording external A/V data which are stored in the memory and displayed through the display.

11. The multi-functional eyeglasses as claimed in claim 1, further comprising:
a switch set for switching the system and turning on and off all other device.

12. The multi-functional eyeglasses as claimed in claim 1, further comprising:
a battery for supplying power to all elements;
a power plug connect to external electric power source;
at least one solar energy chip connected to the battery serves for receiving solar power and converting the solar power to electric power which is then stored in the battery; and
a light source connected to the battery serves for emitting light as guiding light at night.

13. The multi-functional eyeglasses as claimed in claim 1, further comprising:
a GPS positioning system connected to the display for capturing satellite signals to get the position of the eyeglasses.

14. The multi-functional eyeglasses as claimed in claim 1, further comprising:
at least one computer game software stored on the memory; wherein by using the display, the processor, and the speaker, users can play a game.

15. The multi-functional eyeglasses as claimed in claim 1, further comprising:
a Bluetooth system built in the processor and the memory for wireless communication.

16. The multi-functional eyeglasses as claimed in claim 3, further comprising:
a sound control device connected to the processor and having a sound control protocol built in the processor and the memory for sound-controlling external devices.

17. The multi-functional eyeglasses as claimed in claim 3, wherein the receivers receive financial data including stock data, futures data, and exchange rates.

18. The multi-functional eyeglasses as claimed in claim 1, wherein the display is combined with the lenses or independent from the lenses.

19. The multi-functional eyeglasses as claimed in claim 1, wherein the display is added with a touch control device.

20. (canceled)

21. The multi-functional eyeglasses as claimed in claim 1, wherein the processor has a timer for showing time of the display.
